(19) United States
(12) Patent Application Publication
(10) Pub. No.: US 2025/0134156 A1
(43) Pub. Date: May 1, 2025

(54) DEVICE AND METHOD FOR GRINDING HERBS AND TOBACCO

(71) Applicant: Lifted Limited, LLC, Boulder, CO (US)

(72) Inventors: Matthew Robert Bodenchuk, Boulder, CO (US); Leslie Renea Bodenchuk, Boulder, CO (US); Braden Smith, Lafayette, CO (US)

(73) Assignee: Lifted Limited, LLC, Boulder, CO (US)

(21) Appl. No.: 18/934,595

(22) Filed: Nov. 1, 2024

Related U.S. Application Data
(60) Provisional application No. 63/595,239, filed on Nov. 1, 2023.

(51) Int. Cl. A24B 7/04; A47J 42/24; A47J 42/34

(52) U.S. Cl. CPC A24B 7/04; A47J 42/24; A47J 42/34

(57) ABSTRACT

A grinder is provided that grinds materials such as tobacco, herb, spices, or food into smaller pieces for subsequent use. In some embodiments, relative motion between two components grinds the material into smaller pieces. In some embodiments, a cord is used to induce rotational motion between components. In various embodiments, a gear system having a driver is used to induce rotational motion where the driver is moved against a surface to drive the gear system. In some embodiments, a user moves a collar, a handle, or other component to induce rotational motion or longitudinal motion to grind the material.

### CROSS REFERENCE TO RELATED APPLICATIONS

This application claims the benefit of priority to U.S. Provisional Patent Application No. 63/595,239 filed on Nov. 1, 2023, the entire contents of which are incorporated herein by reference.

### FIELD OF THE INVENTION

Embodiments of the present invention generally relate to a grinder for grinding herbs, tobacco, and other materials. More specifically, the grinder can be manually operated and portable so the grinder can be used to grind materials while on the go.

### BACKGROUND OF THE INVENTION

Although tobacco products have been produced and sold as pre-manufactured products (such as pre-made cigarettes and cigars) by commercial enterprises for more than 100 years, there remains a demand in the art for handmade or custom-made tobacco and related products. Additionally, some people prefer smoking tobacco or other materials out of a pipe.

For example, many smokers or consumers of smokeable products believe that “roll-your-own” tobacco or smoking products, including pipes, are not as harmful to human health as commercially sold smoking products. This is, in part, because a person hand rolling a smokeable product, such as a cigarette or cigar, can control the specific content of the product and therefore potentially eliminate, or at least limit, undesirable chemicals in the custom “rolling” process. The same is true for packing a pipe.

In addition to the above reasons, there is also sometimes a social factor which lends to the desirability of hand or custom rolling smokeable products or pipes. For example, “hookah” smoking has become popular in recent years with restaurants sometimes including hookah bar or smoking areas. Entire lounges devoted to hookah smoking have also emerged on the social scene.

Furthermore, it may be desirable to add or substitute smokeable substances, in custom rolled smoking products, to obtain custom, smokeable “cigarettes” which contain smokable matter not otherwise readily available in pre-manufactured cigarette products. For example, custom rolling of cigarette type products which contain flavored tobacco(s), cloves, mixtures of tobaccos, or even cannabis (where legal, or for legal, medical purposes) is possible.

Producing a rolled up cigar or cigarette or smoking a pipe requires tobacco that has been ground into very small pieces from a dried tobacco leaf. The ground tobacco is rolled into a cigar or cigarette using rolling paper so that the user may smoke it. The ground tobacco is also suitable to be smoked with a conventional smoking pipe. Before the 1900s, dried tobacco leaves were commonly ground down by means of the palm of the hand and fingers until the pieces were small enough to be used in a cigar or cigarette. In the early 1900s, innovative devices were developed to grind tobacco and other smoking materials.

A tobacco grinder is a tool for grinding dry tobacco leaves into small pieces. Generally, after the tobacco leaves are ground by the tobacco grinder, it is necessary to use your hand or other tools to take the ground tobacco leaves out of the grinder and put them into rolling papers or fill them into a smoke pan of an electronic cigarette or the bowl of a pipe for use. There can be spillage and waste when taking out the ground tobacco from the grinder.

Today, the most widely used tobacco grinder design is one with three cavities, a top cap, and a bottom cap. The top half of the first cavity is formed by the top cap. A plurality of grinding knives (also called blades or teeth) protrudes from the top cap. The bottom half of the first cavity also has a plurality of grinding knives and several large holes that lead into the second cavity. The second cavity has a screen that leads into the third cavity. The bottom half of the third cavity is formed by the bottom cap of the grinder.

A dried tobacco leaf is placed inside the first cavity. The top cap is then rotated relative to the rest of the grinder allowing the grinding knives to cut the tobacco into smaller pieces. The smaller tobacco pieces are then passed through the large holes into the second cavity and then through the screen into the third cavity. The pieces in the second cavity can then be directed back to the first cavity for further grinding. The ground tobacco in the third cavity is collected in the bottom cap which is removed by the user when ready to smoke it.

Some tobacco grinders are electric and either use batteries (chargeable or replaceable) or plug into an outlet. Other grinders are manual, where a portion of the grinder is rotated by the user.

### SUMMARY OF THE INVENTION

There are many drawbacks with tobacco grinders currently sold on the market. For example, ground material can remain in various portions of the grinder and can be difficult to remove. There is mess associated with scooping or pouring out ground tobacco from the grinder. Electric grinders are expensive, large, heavy, and need power, i.e., batteries or plugs. Electric grinders also have additional pieces and parts that can break or malfunction. Electric grinders can be difficult to clean since the electronic components cannot get wet.

Note that the grinder described herein can be used for herbs, tobacco, spices, food, etc., but is simply called a “grinder” herein. The “contents” or “material” put into the grinder and ground by the grinder can be herb, tobacco, spices, food, and other products typically ground by a user prior to use of the product.

These and other needs are addressed by the various embodiments and configurations of the present invention. This invention relates to a novel system, device, and methods for providing a portable manual herbs, tobacco, spices, and food grinder. The novel grinder provided herein is small enough to fit in a user's pocket and does not require any power or batteries.

Thus, it is one aspect of various embodiments of the present invention to provide a small grinder that is portable and can be easily transported in a user's bag or pocket without spilling, making a mess, or breaking.

It is another aspect of various embodiments of the present invention to provide a grinder that is operated manually such that no electronic components are necessary. One advantage of some embodiments is that the grinder has minimal parts, which means there are fewer parts to break and/or cause a malfunction. Thus, the grinder is more reliable than prior art tobacco and herb grinders and current and prior art electric grinders.

It is one aspect of various embodiments of the present invention to provide a grinder with a funnel-shaped exit portion to enable a user to cleanly pour the material into a pipe, rolling papers, electronic cigarette, or other smoking utensil. In some embodiments, the grinder includes an auger to push the ground tobacco, herb, or other material out of the grinder and out of the funnel in further embodiments.

It is a further aspect of various embodiments of the present disclosure to provide a grinder that utilizes the relative motion between two components to grind material into smaller pieces.

In some embodiments, the grinder has a first housing and a second housing with a space therebetween. The first housing has a first cavity in which material can be disposed, and the second housing has a second cavity in which material can be disposed. An axle spans the first and second housings where a set of first blades extends from the axle into the first cavity and a set of second blades extends from the axle into the second cavity. A cord extends from the axle and from the space between the first and second housings. The cord can be wrapped around the axle to begin operation of the grinder. Then, the cord can be pulled to impart rotational motion to the axle and the first and second housings. Once the cord is fully unrolled, the axle stops rotational motion and the first and second housings continue rotational motion. Thus, there is relative rotational motion between the axle and the first and second housings such that the first and second blades grind the material into smaller pieces.

In various embodiments, the grinder has a housing with a main cavity and a loading cavity. A rotor is positionable in the main cavity and the rotor has at least one aperture extending from an outer surface to an inner surface, which defines an interior volume of the rotor. With the rotor positioned at least partially in the main cavity, material is loaded in the loading cavity against the outer surface of the rotor. A loader can also be positioned in the loading cavity to press the material into the outer surface of the rotor and to prevent material from falling out of the grinder. Then, a user moves the rotor relative to the housing to grind the material. This movement can be rotational or longitudinal. When ground to a smaller size, the material passes through the at least one aperture into the interior volume. An auger positioned at an opposing end of the housing from the rotor can extend at least partially in the main cavity. A user can engage the auger to turn a blade and move material from the interior volume of the rotor to a distal end of the housing. Finally, a user can remove a cover on the distal end and access the ground material for subsequent use.

In some embodiments, the grinder has a housing extending between a closed end and an open end with an interior volume therebetween. Material can be loaded into the interior volume and then a cylinder can be positioned in the interior volume. Relative rotational motion between the housing and the cylinder causes at least one blade of the housing and at least one blade of the cylinder to grind the material. To cause the housing to rotate, a driver to pressed and moved along a surface. The driver turns a sun gear against at least one planetary gear, which is engaged to the housing against a ring gear. Thus, the housing serves as a carrier of the gear system, and the housing turns faster than the driver. Once the material is ground, it can pass through an aperture in the cylinder and into an interior volume of the cylinder. Like other embodiments described herein, an auger and move the material to an end of the grinder.

In some embodiments, the cylinder is positioned in a housing or collar, and a user rotates the housing or collar by hand. In further embodiments, the housing or collar comprises a handle by which the user can rotate the housing or collar faster and with more leverage.

A first aspect of the present disclosure is to provide a grinder, comprising a first housing defining a first cavity configured to receive a first portion of material; a second housing defining a second cavity configured to receive a second portion of material; an axle extending between the first and second housings, wherein a set of first blades extends from the axle into the first cavity, and a set of second blades extends from the axle into the second cavity; and a cord extending from the axle, wherein the cord is configured to induce relative rotational motion between the axle and the first and second housings such that the set of first blades is configured to grind the first portion of material in the first cavity and such that the set of second blades is configured to grind the second portion of material in the second cavity.

A second aspect of the present disclosure is to provide a grinder, comprising a housing having a main body defining a main cavity and having a loading body defining a loading cavity that is configured to receive material; a rotor having a shaft that comprises at least one aperture and that is configured to be at least partially positioned in the main cavity; and a loader having a shaft that is configured to be at least partially positioned in the loading cavity and that is configured to press material into an outer surface of the shaft of the rotor; wherein the rotor is configured to move relative to the housing to grind the material in smaller pieces that pass through the at least one aperture in the shaft of the rotor and into an interior volume of the shaft of the rotor.

The grinder of the second aspect may include, optionally, that the rotor is configured to move in at least one of a rotational direction and a longitudinal direction.

The grinder of the second aspect may include one or more of the previous embodiments and, optionally, an auger having a blade that is configured to be at least partially positioned in the main cavity and at least partially positioned within the interior volume of the shaft of the rotor, wherein the auger is configured to be rotatable relative to the housing to move smaller pieces of material from the interior volume of the shaft to a distal end of the grinder.

A third aspect of the present disclosure is to provide a grinder, comprising a housing having an interior volume and at least one blade extending into the interior volume; a cylinder that is positionable in the interior volume of the housing, wherein the cylinder has at least one blade extending from an outer surface of the cylinder; and a gear system engaged with a distal end of the housing, wherein rotation of a driver of the gear system causes the housing to rotate at a faster speed than the driver, and rotation of the housing relative to the cylinder causes the at least one blade of the housing and the at least one blade of the cylinder to grind material therebetween.

The grinder of the third aspect may include, optionally, a sun gear on the driver; a ring gear on a collar that is graspable by a user; and a planetary gear rotatable on a shaft extending from the distal end of the housing, wherein the sun gear is configured to drive the planetary gear against the ring gear to rotate the housing.

A fourth aspect of the present disclosure is to provide a grinder, comprising a collar extending between a closed end and an open end with an interior volume disposed between the closed and open ends, the collar having at least one blade extending into the interior volume; and a cylinder positionable in the interior volume of the collar, the cylinder having at least one blade extending from an end of the cylinder and having at least one aperture extending through the end; wherein the collar and the cylinder are configured to rotate relative to each other to grind material between the at least one blade of the collar and the at least one blade of the cylinder until the material is sufficiently small to pass through the at least one aperture and into an interior volume of the cylinder.

The grinder of the fourth aspect may include, optionally, a handle connected to an outer surface of the collar, wherein the handle is extendable in a radial direction to provide a user with leverage when rotating the collar.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the invention given above and the detailed description of the drawings given below, serve to explain the principles of the invention.

FIG. 1 is a perspective view of a grinder in accordance with an embodiment of the present disclosure;

FIG. 2 is an exploded, perspective view of the grinder in FIG. 1 in accordance with an embodiment of the present disclosure;

FIG. 3 is a plan view of the grinder in FIG. 1 in accordance with an embodiment of the present disclosure;

FIG. 4 is a cross-sectional view of the grinder in FIG. 3 taken along line A-A in accordance with an embodiment of the present disclosure;

FIG. 5 is a perspective view of a grinder in accordance with an embodiment of the present disclosure;

FIG. 6 is an exploded, perspective view of the grinder in FIG. 5 in accordance with an embodiment of the present disclosure;

FIG. 7 is a plan view of the grinder in FIG. 5 in accordance with an embodiment of the present disclosure;

FIG. 8 is a cross-sectional view of the grinder in FIG. 7 taken along line A-A in accordance with an embodiment of the present disclosure;

FIG. 9 is a perspective view of a grinder in accordance with an embodiment of the present disclosure;

FIG. 10 is an exploded, perspective view of the grinder in FIG. 9 in accordance with an embodiment of the present disclosure;

FIG. 11 is a plan view of the grinder in FIG. 9 in accordance with an embodiment of the present disclosure;

FIG. 12 is a cross-sectional view of the grinder in FIG. 11 taken along line A-A in accordance with an embodiment of the present disclosure;

FIG. 13 is an exploded, perspective view of a grinder in accordance with an embodiment of the present disclosure;

FIG. 14 is a plan view of the grinder in FIG. 13 in accordance with an embodiment of the present disclosure;

FIG. 15 is a cross-sectional view of the grinder in FIG. 14 taken along line A-A in accordance with an embodiment of the present disclosure;

FIG. 16 is a perspective view of a grinder in accordance with an embodiment of the present disclosure;

FIG. 17 is an exploded, perspective view of the grinder in FIG. 16 in accordance with an embodiment of the present disclosure;

FIG. 18 is a plan view of the grinder in FIG. 16 in accordance with an embodiment of the present disclosure;

FIG. 19 is a cross-sectional view of the grinder in FIG. 18 taken along line A-A in accordance with an embodiment of the present disclosure;

FIG. 20 is a plan view of the grinder in FIG. 16 in a further position in accordance with an embodiment of the present disclosure;

FIG. 21 is a cross-sectional view of the grinder in FIG. 20 taken along line A-A in accordance with an embodiment of the present disclosure;

FIG. 22 is a perspective view of a grinder with a handle in a first position in accordance with an embodiment of the present disclosure; and

FIG. 23 is a perspective view of the grinder in FIG. 22 with the handle in a second position in accordance with an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.
2 Grinder
4 First Housing
6 Second Housing
8 Cord
10 Axle
12 First Blades
13 Cutting Edge
14 First Cover
15 Spine
16 First Cavity
18 Second Blades
20 Second Cover
22 Second Cavity
24 Grinder
26 Housing
28 Rotor
30 Loader
32 Auger
34 Cover
36 Main Body
38 Loader Body
40 End (Rotor)
42 Shaft (Rotor)
44 Aperture
45 Interior Volume (Rotor)
46 End (Loader)
48 Shaft (Loader)
50 Blade
52 Funnel
54 Main Cavity
56 Loader Cavity
58 Grinder
60 Housing
61 Gear System
62 Driver
64 Collar
66 Auger
68 Cover
70 Sun Gear
72 Ring Gear
74 Planetary Gear
76 Shaft
78 Cylinder
80 Aperture
82 Blade (Cylinder)
84 Blade (Auger)
86 Funnel
87 Interior Volume (Housing)
88 Blade (Housing)
89 Interior Volume (Cylinder)
90 Grinder
92 Cylinder
94 Collar
96 Auger
98 Cover
100 Blade (Cylinder)
102 Aperture
104 Blade (Auger)
106 Funnel
107 Interior Volume (Collar)
108 Blade (Collar)
109 Interior Voume (Cylinder)
110 Handle
112 Arm
114 Knob

### DETAILED DESCRIPTION

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

The figures show various embodiments of the grinder in accordance with the present disclosure. Components and elements of one embodiment of the grinder can be utilized with another embodiment of the grinder and/or combined with components and elements from another embodiment of the grinder.

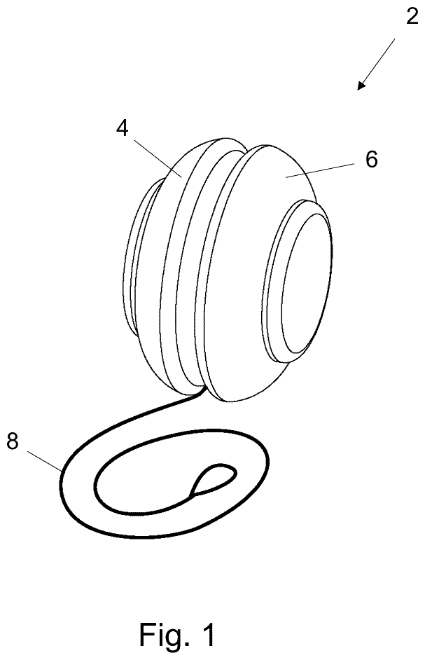

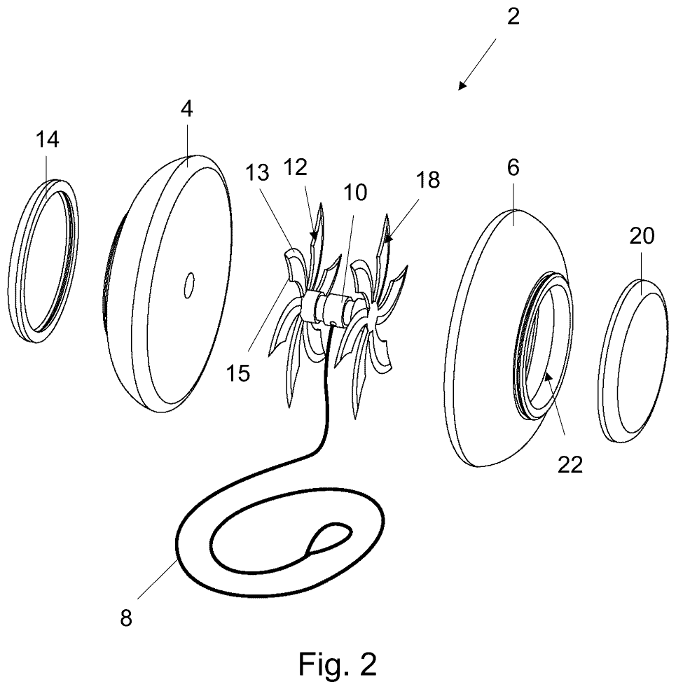

FIG. 1 is a perspective view and FIG. 2 is an exploded view of a grinder 2 that uses rotational motion to grind material such as tobacco, herb, spices, food, etc. into smaller pieces. The grinder 2 generally comprises a first housing 4 and a second housing 6 that are, in this embodiment, symmetrically arranged relative to each other with a cord 8 extending therebetween. As shown in FIG. 2, the cord 8 is attached to an axle 10 that has a set of first blades 12 and a set of second blades 18 that grind material within the first and second housings 4, 6, respectively.

The set of first blades 12 has six blades of equal size and shape and that are evenly arrayed about the axle 10. Each blade of the set of first blades 12 tapers away from the axle 10 such that a cutting edge 13 is longer than a spine 15. In other embodiments, both sides of each blade are cutting edges. Moreover, in other embodiments, each blade is symmetrical about a line extending from a base to a point of the blade where the cutting edge 13 and the spine 15 meet. It will be appreciated that the set of first blades 12 may comprise more or fewer than six blades. In addition, the set of first blades 12 may project in an axial direction from, for example, a disc.

The set of second blades 18 extends from the axle 10 where the set of second blades 18 is identical to the set of first blades 12. However, it will be appreciated that the set of second blades 18 can be rotational offset from the set of first blades 12 about an axis of the axle 10. Moreover, the set of second blades 18 can be wholly different than the set of first blades 12 where, for instance, the set of first blades 12 can grind material to a first size, and then the set of second blades 18 can grind the material to a second, smaller size.

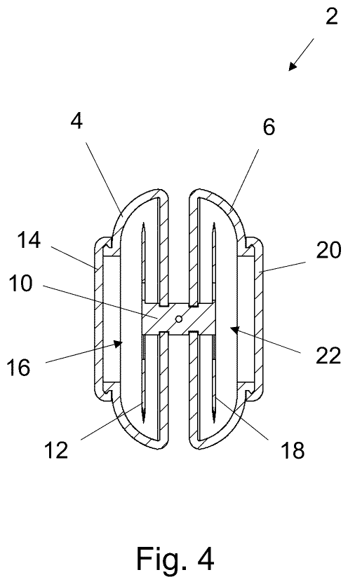

When the grinder 2 is assembled, the set of first blades 12 is positioned within the first housing 4, and the set of second blades 18 is positioned within the second housing 6. A user can load material in a first cavity (16 in FIG. 4) in the first housing 4 and then close the first cavity with a first cover 14. Similarly, a user can load material in a second cavity 22 in the second housing 6 and then close the second cavity 22 with a second cover 20.

To operate the grinder 2, the user first winds the cord 8 about the axle 10. Then, the user grasps the cord 8 and lets the rest of the grinder 2, including the axle 10 and housings 4, 6, fall downward. As the cord 8 unravels, the axle 10 and housings 4, 6 rotate. When the cord 8 fully unravels, the axle 10 stops rotating and the housings 4, 6 continue to rotate relative to the axle 10 including the sets of blades 12, 18. This relative rotational motion between the housings 4, 6 and the sets of blades 12, 18 grinds the materials in the housings 4, 6. The user can repeat the cycle to further grind the material. Finally, the user removes the materials from the housings 4, 6 for subsequent use. In some embodiments, each housing 4, 6 may optionally comprise an auger and/or funnel as described in further detail herein.

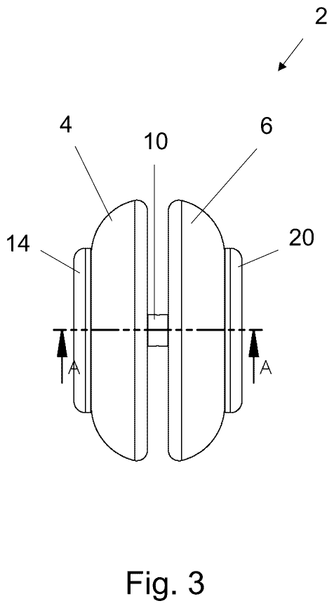

FIG. 3 shows a plan view of the grinder 2, and FIG. 4 is a cross-sectional view of the grinder 2 taken along line A-A in FIG. 3. The covers 14, 20 are snap fit or deflected into position on a protruding portion of the respective housings 4, 6. It will be appreciated that in some embodiments, one or both of the housings 4, 6 can comprise teeth or blades extending from an inner surface into the respective cavities 16, 22 to further grind the materials into smaller pieces.

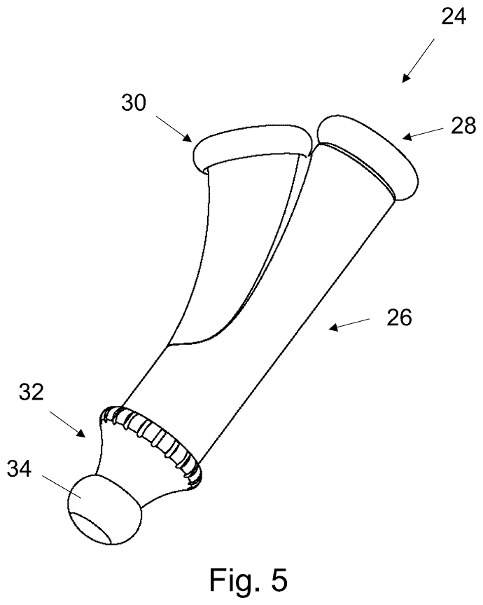

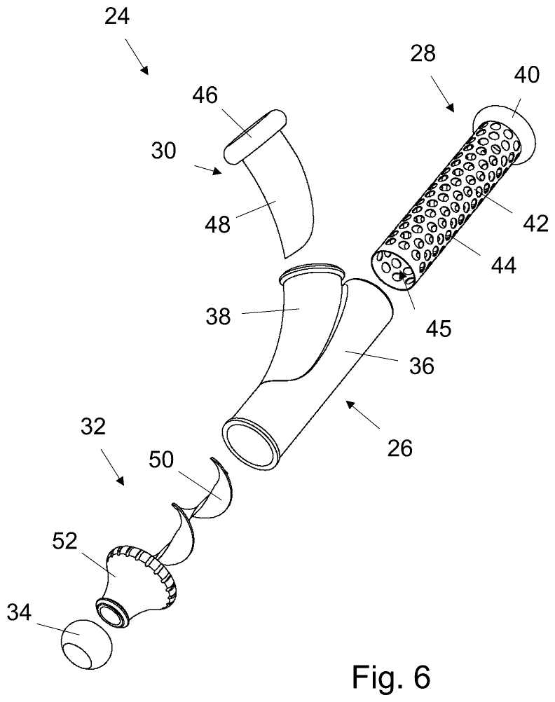

FIG. 5 shows a perspective view of another grinder 24, and FIG. 6 shows an exploded view of the grinder 24. The grinder 24 generally comprises a housing 26, a rotor 28, a loader 30, an auger 32, and a cover 34. As described herein, the rotor 28 can be inserted into the housing 26, and material can be inserted into the loader 30. Then, the rotor 28 can move to grind the material, and the auger 32 can rotate to direct the material to a distal end of the grinder 24 where the cover 34 is selectively removable to dispense the material.

As shown in FIG. 6, the housing 26 comprises a main body 36 and a loader body 38. The rotor 28 comprises an end 40 that is engageable by a user, a shaft 42 extending from the end 40, and at least one aperture 44 extending through the shaft 42. The loader 30 comprises an end 46 and a shaft 48 extend from the end 46. The auger 32 comprises a blade 50 that spirals about a longitudinal axis and a funnel 52 that directs material to an open distal end.

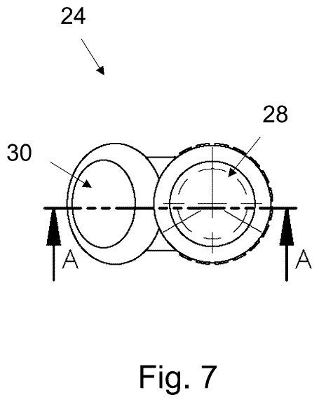

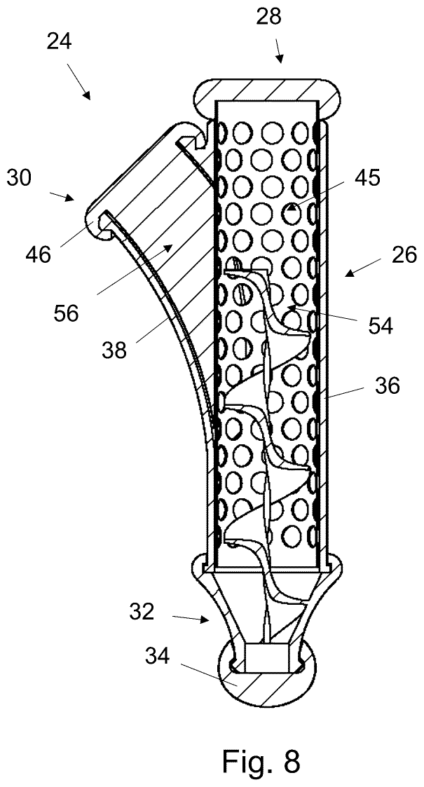

FIG. 7. is a plan view of the grinder 24, and FIG. 8 is a cross-sectional view of the grinder 24 taken along line A-A in FIG. 7. To operate the grinder 24, the rotor 28 is positioned within a main cavity 54 of the main body 36 of the housing 26. Material is inserted into a loader cavity 56 of the loader body 38 of the housing 26, and then the loader 30 is inserted into the loader cavity 56 to press the material against an outer surface of the rotor 28. In some embodiments, the end 46 snaps into place against the loader body 38, which creates a force that drives the material into the outer surface of the rotor 28. In other embodiments, a bias member imposes a force, with either linear or non-linear response, against the material. In various embodiment, the loader 30 has a locking feature to prevent the loader 30 from being separated from the rest of the grinder 24.

Next, the user moves the rotor 28 relative to the housing 26, which grinds the material. This movement can be a rotational movement or a longitudinal movement. Once the material is ground to a sufficiently small size, pieces of the material pass through the at least one aperture (44 in FIG. 6) into an interior volume 45 of the rotor 28. A user can rotate the auger 32 so that the blade (50 in FIG. 6) moves the pieces of the material to the distal end of the grinder 24. Then, a user can remove the cover 34 to access the ground material.

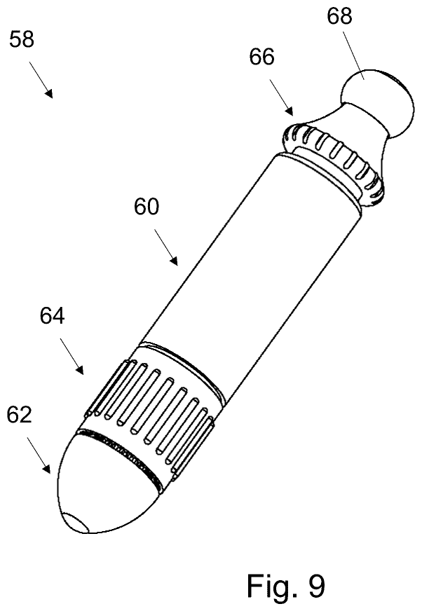

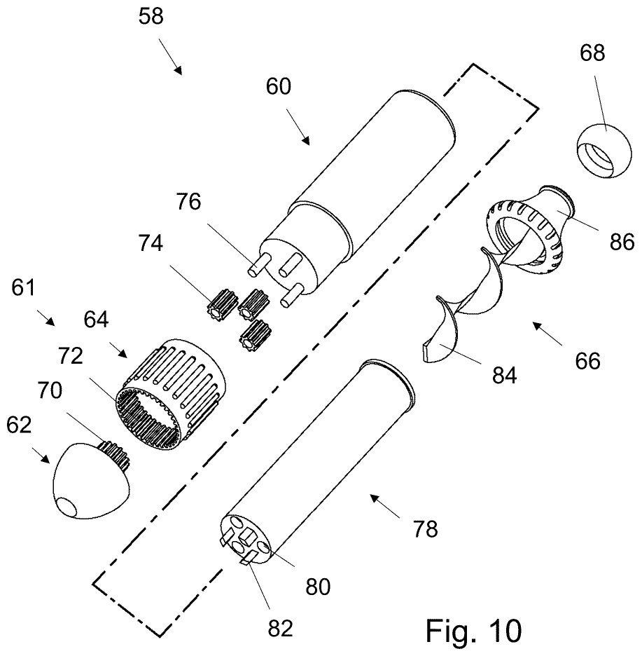

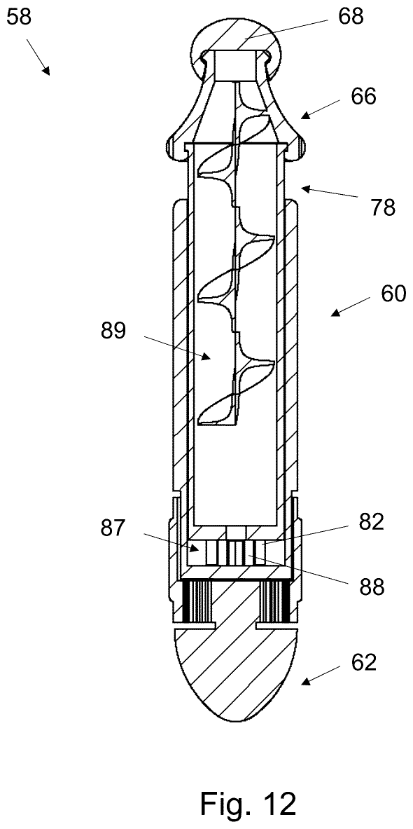

FIG. 9 shows a perspective view of another grinder 58, and FIG. 10 shows an exploded view of the grinder 58. The grinder 58 comprises a housing 60, a driver 62, a collar 64, an auger 66, and a cover 68. As shown in FIG. 10, the grinder 58 also has a cylinder 78 that is positionable in the housing 60. To operate the grinder 58, material is loaded into an interior volume (87 in FIG. 12) within the housing 60, then the cylinder 78 is positioned in the housing 60, and the relative rotational motion between the housing 60 and the cylinder 78 grinds the material to a smaller size.

To induce the relative rotational motion, the grinder 60 has a gear system 61 with the driver 62 at a distal end of the grinder 58. The driver 62 has a sun gear 70 that engages at least one planetary gear 74, which rotates against a ring gear 72 of the collar 64. In this embodiment, there are three planetary gears 74, each rotating about a respective shaft 76 that extends from the housing 60. In this gear system 61, the housing 60 serves as the carrier for the planetary gears 74. A user can grasp the collar 64 and then rotate the driver 62 against a surface like a tabletop or a ground surface. The rotation of the driver 62 causes the sun gear 70 to drive the planetary gears 74 and the housing 60 such that the housing 60 rotates faster than the driver 62. As described in further detail herein, blades in the interior volume (87 in FIG. 12) of the housing 60 work against blades 82 on the cylinder 78 to grind material into pieces small enough to pass through the aperture 80. Once the material is in the cylinder 78, a user can operate the auger 66 to drive a blade 84 and funnel 86 to move material to a proximal end of the grinder 58 where a user can remove a cover 68 to access the material.

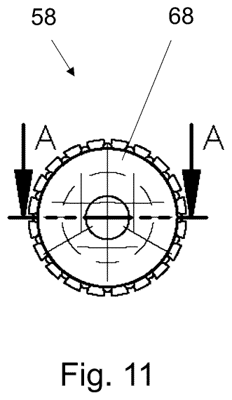

FIG. 11 is a plan view of the grinder 58, and FIG. 12 is a cross-sectional view of the grinder 58 taken along line A-A in FIG. 11. FIG. 12 shows the cylinder 78 positioned in an interior volume 87 of the housing 60. The blades 88 of the housing 60 cooperate with the blades 82 of the cylinder 78 to grind material. It will be appreciated that various embodiments comprise different numbers, arrangements, and/or orientations of the blades 82, 88. A user can reorient the grinder 58 such that sufficiently small pieces of material pass through the aperture (80 in FIG. 10) and into an interior volume 89 of the cylinder 78. Then, a user can engage the auger 66 and cover 68 to retrieve the material.

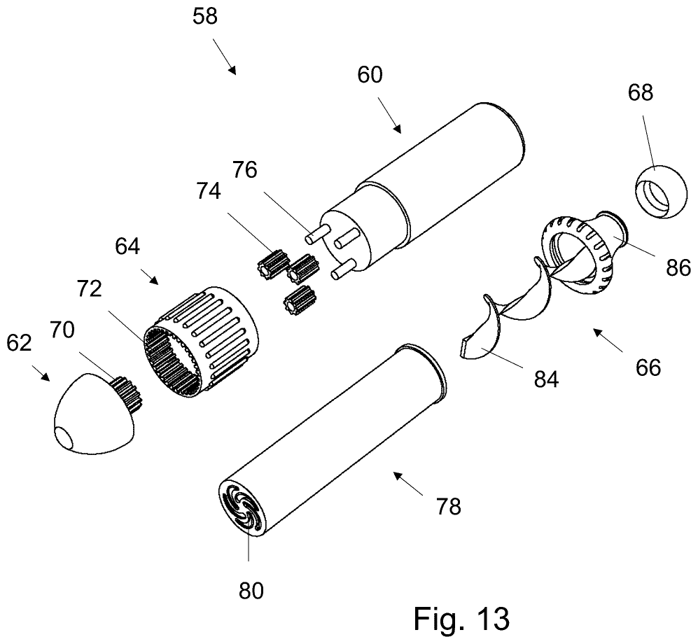

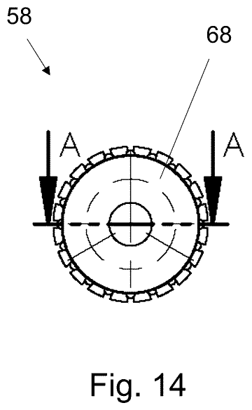

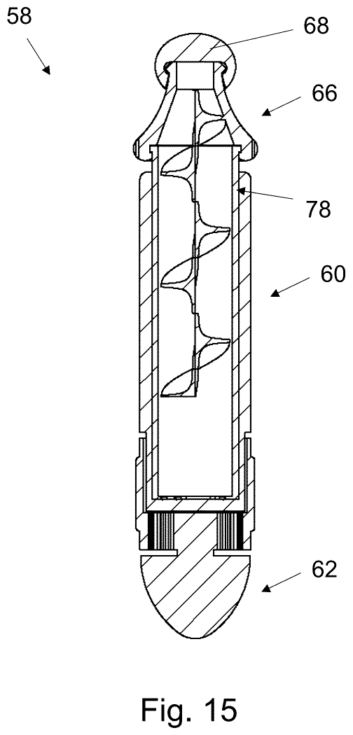

FIG. 13 is an exploded view of another embodiment of the grinder 58 shown in FIG. 9. FIG. 14 is a plan view of the grinder 58 in FIG. 13, and FIG. 15 is a cross-sectional view of the grinder 58 taken along line A-A in FIG. 14. This grinder 58 is similar to the grinder shown in FIG. 9. However, the grinder 58 shown in FIGS. 13-15 has an aperture 80 without blades, and a user presses the cylinder 78 into the housing 60 to grind material positioned between the cylinder 78 and the housing 60. It will be appreciated that further embodiments may have protrusions or blades or other structures extending from the housing 60 and/or the cylinder 78 to aid in grinding the material.

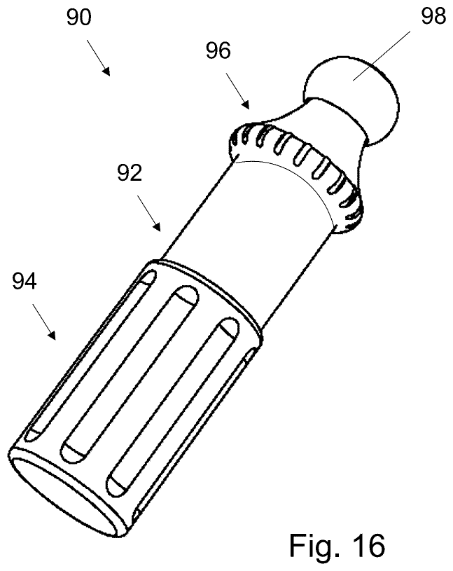

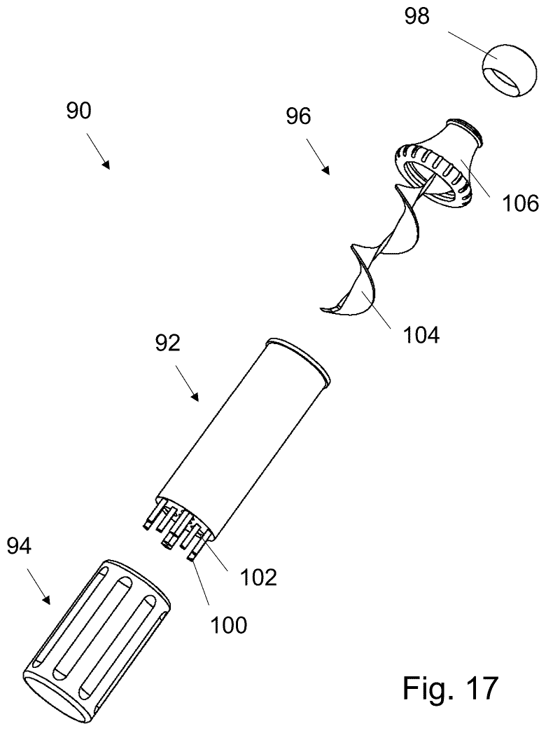

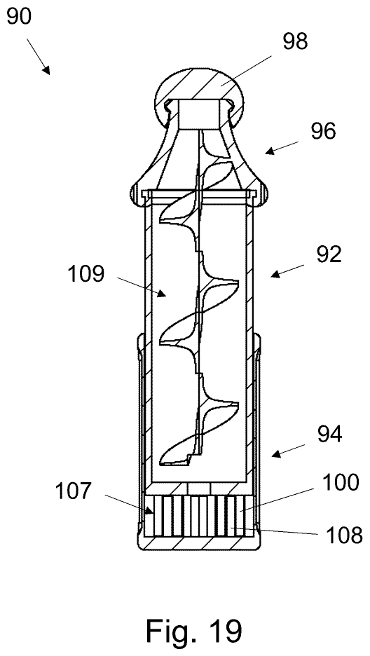

FIG. 16 is a perspective view of a further grinder 90, and FIG. 17 is an exploded view of the grinder 90. The grinder 90 comprises a cylinder 92, a collar 94 or housing, an auger 96, and a cover 98. FIG. 17 shows the cylinder 92 having at least one blade 100 and an aperture 102 providing access to an interior volume (109 in FIG. 19) of the cylinder 92. The auger 96 comprises a blade 104 and a funnel 106. To operate the grinder 90, a user loads material into the collar 94, and then positions the cylinder 92 within the collar 94. The user rotates the collar 94 and the cylinder 92 relative to each other. This causes the blades 100 on the cylinder 92 and, in this embodiment, the blades on the collar 94 to grind the material into smaller pieces. When the pieces are sufficiently small, they pass through the aperture 102 into the cylinder 92. Then a user can operate the auger 96 and the cover 98 to retrieve the material.

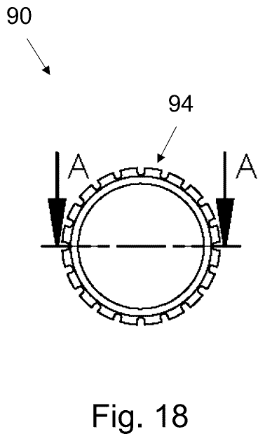

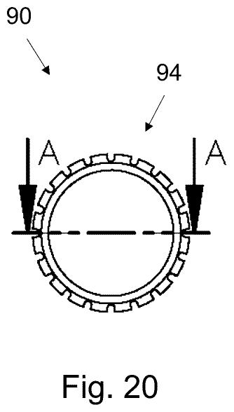

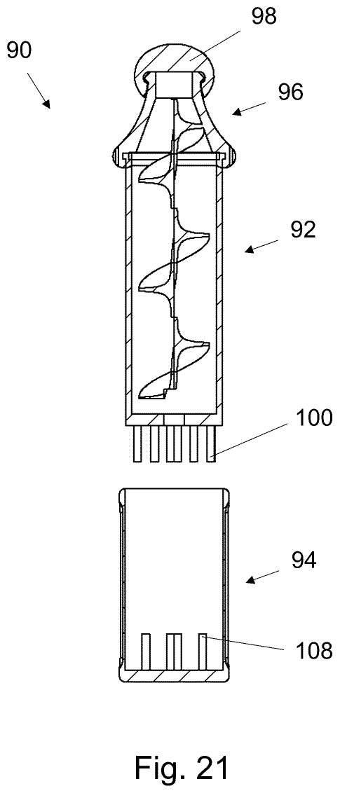

FIG. 18 is a plan view of the grinder 90, and FIG. 19 is a cross-sectional view of the grinder 90 take along line A-A in FIG. 18. FIG. 20 is a plan view of the grinder 90 in a different position, and FIG. 21 is a cross-sectional view of the grinder 90 taken along line A-A in FIG. 20. These figures show that the cylinder 92 is positioned in an interior volume 107 of the collar 94. The blades 108 extend from the collar 94 and cooperate with the blades 100 of the cylinder 92 to grind material into smaller pieces that pass through an aperture and into an interior volume 109 of the cylinder 92.

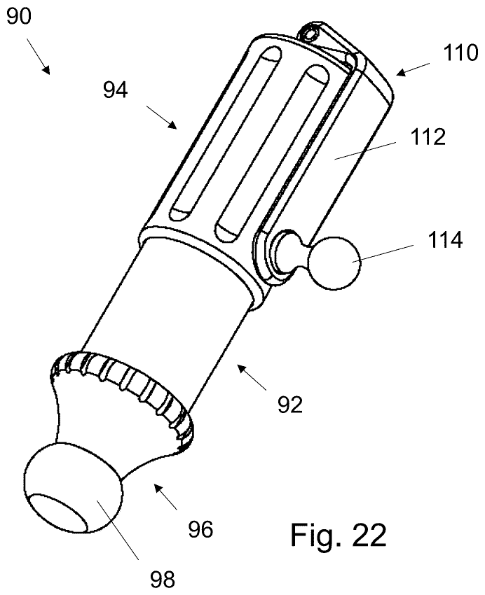

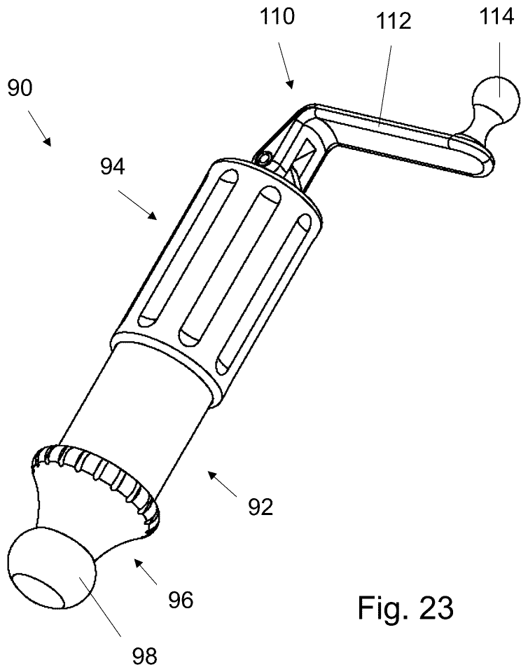

FIGS. 22 and 23 show a further embodiment of the grinder 90 in FIGS. 16-21 where a handle 110 extends from the end of the collar 94. The handle 110 has an articulable arm 112 and a knob 114. FIG. 22 shows the handle 110 in a non-operational position, and FIG. 23 shows the handle 110 in an operational position. The user can engage the knob 114 when the handle 110 is in the operational position to more easily rotate the collar 94 and the cylinder 92 relative to each other.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

Additionally, various features/components of one embodiment may be combined with features/components of another embodiment. For example, features/components of one figure can be combined with features/components of another figure or features/components of multiple figures. To avoid repetition, every different combination of features has not been described herein, but the different combinations are within the scope of this disclosure. Additionally, if details (including angles, dimensions, etc.) about a feature or component are described with one embodiment or one figure, then those details can apply to similar features of components in other embodiments or other figures.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

It is to be appreciated that any feature described herein can be claimed in combination with any other feature(s) as described herein, regardless of whether the features come from the same described embodiment.

What is claimed is:

1. A grinder, comprising:
a first housing defining a first cavity configured to receive a first portion of material;
a second housing defining a second cavity configured to receive a second portion of material;
an axle extending between the first and second housings, wherein a set of first blades extends from the axle into the first cavity, and a set of second blades extends from the axle into the second cavity; and
a cord extending from the axle, wherein the cord is configured to induce relative rotational motion between the axle and the first and second housings such that the set of first blades is configured to grind the first portion of material in the first cavity and such that the set of second blades is configured to grind the second portion of material in the second cavity.

2.-8. (canceled)

9. A grinder, comprising:
a housing having a first end, a second end, and a main body therebetween defining a main cavity therein;
a load cavity configured to receive material;
an aperture in the housing such that the load cavity is operably connected to the main cavity;
a grind feature positioned proximate to the aperture; and
a drive member disposed at the first end of the housing, wherein actuation of the drive member is configured to drive the grind feature into the material to grind the material into smaller pieces that can pass through the aperture from the load cavity into the main cavity.

10. The grinder of claim 9, wherein the drive member is configured to move in at least one of a rotational direction and a longitudinal direction.

11. The grinder of claim 9, wherein the housing further comprises an additional grind feature, and wherein the grind features are configured to grind the material into smaller pieces.

12. The grinder of claim 11, wherein the grind features are blades that each have at least one cutting edge configured to grind the material in the load cavity into smaller pieces.

13. The grinder of claim 11, wherein a rotor is at least partially positioned in the main cavity, wherein the grind feature is an outer surface of the rotor having a plurality of holes, and the drive member is an end of the rotor such that at least one of rotational and longitudinal movement of the end drives the rotor which is configured to grind the material in the load cavity into smaller pieces.

14. The grinder of claim 9, further comprising a funnel engageable to the second end of the housing, wherein the funnel has an opening to dispense the smaller pieces of the material.

15. The grinder of claim 14, further comprising a cover engageable to the funnel to cover the opening and prevent dispensation of the smaller pieces of the material.

16. The grinder of claim 14, further comprising:
an auger that is affixed to an interior surface of the funnel and configured to be at least partially positioned in the main cavity, wherein the auger spirals about a longitudinal axis relative to the housing thereby directing the smaller pieces of the material from the main cavity toward the opening of the funnel.

17. The grinder of claim 16, further comprising:
a flange disposed about the second end of the housing, wherein the funnel is configured to engage the flange such that a longitudinal position of the funnel is fixed relative to the housing, and the funnel is rotatable relative to the housing to move the smaller pieces of the material contained within the main cavity along the auger toward the opening.

18. The grinder of claim 16, further comprising a loader that is at least partially positionable in the load cavity, and the loader is configured to press the material into the grind feature.

19. The grinder of claim 9, further comprising a cylinder positioned about the housing, wherein actuation of the drive member is configured to rotate the cylinder relative to the housing to drive the grind feature into the material.

20. The grinder of claim 19, further comprising a planetary gear system that translates rotation of the drive member to rotation of the cylinder, wherein the drive member comprises a sun gear, the cylinder comprises at least one planetary gear, and a collar comprises a ring gear.

21. The grinder of claim 9, further comprising a handle securably engaged to an exterior surface of the drive member, wherein the handle is operatable to actuate the drive member by rotating the drive member.

22. The grinder of claim 21, wherein the handle is movable from a first position to a second position, and wherein the handle is rotatable about a longitudinal axis of the housing when in the second position.

23. A grinder, comprising:
an inner housing positionable within an outer housing, wherein the inner housing has a first end, a second end, and an inner body therebetween defining a main cavity of the inner housing, and wherein the outer housing has a first end, a second end, and an outer body therebetween;
a load cavity disposed between the inner and outer housings, the load cavity configured to receive a material;
an aperture in the inner housing such that the load cavity is operably connected to the main cavity;
at least one grind feature positioned proximate to the load cavity, wherein rotation of the inner and outer housings relative to each other is configured to drive the grind feature into the material to grind the material into smaller pieces that can pass through the aperture from the load cavity into the main cavity;
a funnel engageable to the second end of the inner housing, wherein the funnel has an opening to dispense the smaller pieces of the material; and
an auger affixed to an interior surface of the funnel and at least partially positioned in the main cavity, wherein the auger spirals about a longitudinal axis relative to the inner housing such that rotation of the auger is configured to direct the smaller pieces of the material from the main cavity toward the opening of the funnel.

24. The grinder of claim 23, wherein the at least one grind feature has at least one cutting edge configured to grind the material in the load cavity into the smaller pieces.

25. The grinder of claim 23, further comprising:
a flange disposed about the second end of the inner housing, wherein the funnel is configured to engage the flange such that a longitudinal position of the funnel is fixed relative to the inner housing, and the funnel is rotatable relative to the inner housing to move the smaller pieces of the material contained within the main cavity along the auger toward the opening.

26. The grinder of claim 23, further comprising a cover engageable to the funnel to cover the opening and prevent dispensation of the smaller pieces of the material.

27. The grinder of claim 23, further comprising:
a drive member disposed about the first end of the outer housing, wherein actuation of the drive member is configured to rotate the outer housing relative to the inner housing and thereby drive the grind feature into the material to grind the material into the smaller pieces.
